(19) United States
(12) Patent Application Publication
(10) Pub. No.: US 2015/0254694 A1
(43) Pub. Date: Sep. 10, 2015

(54) System and Method for Providing Redeemable Commercial Objects in Conjunction with Geographic Imagery

(71) Applicant: Daniel Joseph Filip, San Jose, CA (US)

(72) Inventor: Daniel Joseph Filip, San Jose, CA (US)

(73) Assignee: GOOGLE INC., Mountain View, CA (US)

(21) Appl. No.: 13/598,766

(22) Filed: Aug. 30, 2012

(51) Int. Cl. G06Q 30/02; G06T 11/60; G06Q 20/36; G06K 9/00

(52) U.S. Cl. CPC G06Q 30/0207; G06K 9/00624; G06T 11/60; G06Q 20/36; G06T 2200/24

(57) ABSTRACT

Systems and methods for displaying content in association with geographic imagery, such as street level imagery are provided. More particularly, digital representations of redeemable commercial objects, such as coupons, promotional offers, discounts, vouchers, gift certificates, etc., can be displayed in conjunction with the geographic imagery. The commercial objects are redeemable at entities depicted in the geographic imagery, such as businesses, restaurants, retail outlets, coffee shops, bars, music venues, etc., depicted in the geographic imagery. For example, a digital representation of a commercial object can be displayed in the geographic image overlaying an entity where the commercial object can be redeemed. As a result, users can browse and/or collect commercial objects redeemable entities depicted in the geographic imagery as the users navigate the geographic imagery.

### FIELD

The present disclosure relates generally to displaying geographic imagery, and more particularly to systems and methods for providing redeemable commercial objects, such as coupons, promotional offers, vouchers, and gift certificates, in conjunction with geographic imagery.

### BACKGROUND

Computerized methods and systems for displaying imagery, in particular geographic imagery are known. In the context of geographic information systems and digital mapping systems, services such as Google Maps are capable of providing street level images of geographical locations. The images, known on Google Maps as “Street View,” typically provide immersive 360° panoramic views of photographs of buildings and other features centered around a geographic area of interest. The panoramic views allow a user to view a geographic location from a person's perspective, as if the user was located on the street level or ground level associated with the geographic location.

User interfaces for navigating immersive panoramic imagery, such as street level imagery, typically allow a user to pan, tilt, rotate, and zoom the panoramic imagery. In certain implementations, a user can select a portion of the imagery using a user manipulable selecting object, such as a cursor, to jump to various different views in the panoramic imagery. Users can navigate the immersive panoramic imagery to get a realistic view of a geographic location from a person's perspective before actually travelling to the geographic area depicted in the immersive panoramic imagery.

### SUMMARY

Aspects and advantages of the invention will be set forth in part in the following description, or may be obvious from the description, or may be learned through practice of the invention.

One exemplary aspect of the present disclosure is directed a computer-implemented method for providing geographic imagery, such as interactive panoramic imagery. The method includes receiving, at a computing device, a request for a geographic image. The geographic image depicts a geographic area associated with a location. The method further includes identifying, with the computing device, at least one entity depicted in the geographic image and identifying a commercial object redeemable at the entity for display in conjunction with the geographic image. Responsive to the request for the geographic image, the method includes providing data for displaying a representation of the commercial object redeemable at the entity in conjunction with the geographic image.

Other exemplary implementations of the present disclosure are directed to systems, apparatus, computer-readable media, devices, and user interfaces for providing geographic imagery, such as interactive panoramic street level imagery.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an exemplary system for displaying geographic imagery according to an exemplary embodiment of the present disclosure;

FIG. 2 depicts an exemplary user interface displaying commercial objects in conjunction with geographic imagery according to an exemplary embodiment of the present disclosure;

FIG. 3 depicts a viewport displaying commercial objects in conjunction with geographic imagery according to an exemplary embodiment of the present disclosure;

FIG. 4 depicts a viewport displaying commercial objects in conjunction with geographic imagery according to an exemplary embodiment of the present disclosure;

FIG. 5 depicts a viewport displaying commercial objects in conjunction with geographic imagery associated with the interior of an entity according to an exemplary embodiment of the present disclosure;

FIG. 6 depicts an exemplary user interface displaying commercial objects in conjunction with geographic imagery according to an exemplary embodiment of the present disclosure;

FIG. 7 depicts a flow diagram of an exemplary method according to an exemplary embodiment of the present disclosure;

FIG. 8 depicts a flow diagram of an exemplary method for identifying commercial objects to be displayed in conjunction with geographic according to exemplary embodiments of the present disclosure; and

FIG. 9 depicts a flow diagram of an exemplary method for identifying commercial objects to be displayed in conjunction with geographic imagery according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to systems and methods for displaying content in association with geographic imagery, such as immersive panoramic imagery including street level imagery. More particularly, digital representations of redeemable commercial objects, such as coupons, promotional offers, discounts, vouchers, gift certificates, etc., are displayed in conjunction with the geographic imagery. The commercial objects are redeemable at entities depicted in the geographic imagery, such as businesses, restaurants, retail outlets, coffee shops, bars, music venues, etc., depicted in the geographic imagery. For example, a digital representation of a commercial object can be displayed in the geographic image overlaying an entity where the commercial object can be redeemed. As a result, users can browse and/or collect commercial objects redeemable at entities depicted in the geographic imagery as the users navigate the geographic imagery.

For instance, a user traveling to a particular geographic area can provide a request to a computing device for geographic panoramic imagery, such as street level imagery, associated with the geographic area from a geographic information system. The requested panoramic imagery can be presented to the user in a user interface, such as a browser, presented on a display device. The user can navigate the panoramic imagery associated with the geographic area to gain familiarity with the geographic area before traveling to the area. As the user navigates the panoramic imagery presented on the display device, commercial objects redeemable at entities depicted in the imagery and that are visible in, for instance, neighboring geographic imagery, can be displayed in conjunction with the panoramic imagery. This allows a user to be notified of commercial objects redeemable at entities in a geographic area associated with the panoramic imagery and allows entities to advertise commercial objects to users looking at panoramic imagery of geographic areas near the entity.

A user can collect the commercial objects as the user navigates the geographic imagery. For instance, as the user is navigating the geographic imagery, the user can interact with a commercial object to collect the commercial object and store the commercial object in, for instance, a digital wallet associated with the user. The user can then redeem the commercial object at the physical location of the entity depicted in the geographic image or online at a website associated with the entity.

According to more particular aspects of the present disclosure, the geographic imagery requested by a user can be analyzed by a computing device, such as a server hosting a geographic information system providing the geographic imagery, to identify an entity depicted in the geographic imagery. The entity can be identified based on orientation information and/or geographic position information associated with the geographic imagery. Once the entity has been identified, one or more commercial objects associated with the entity can be identified and data associated with the commercial objects can be provided to a client device associated with the user to render a digital representation of the commercial object in conjunction with the geographic imagery.

In one aspect, the commercial objects can be identified based on data previously provided by the entity depicted in the geographic imagery. For instance, the entity can request that a commercial object be displayed in conjunction with geographic imagery depicting the entity when the geographic imagery is accessed by a user. The entity can set criteria for displaying the commercial object in association with the geographic imagery. For instance, the entity can request that a commercial object be displayed only when a threshold number of users are accessing the geographic imagery depicting the entity. The entity can also specify criteria based on other factors, such as proximity of users accessing the geographic imagery, the device type associated with the users accessing the geographic imagery, and/or other suitable factors. For instance, the entity can request that a first type of commercial object be displayed to users accessing the geographic imagery from a mobile device and a second type of commercial object be displayed to users accessing the geographic imagery from another type of device. Any location data, proximity data, device type data or other user data would only be used after the user has provided consent after being informed of what data is used and how the data is used. The user can determine how the data is used and can opt-out of such services at any time.

According to another particular aspect of the present disclosure, the entity can be notified when a user accesses geographic imagery depicting the entity. In particular, the entity can be notified of the number of users accessing the geographic imagery and of other information optionally provided by a user, such as the proximity of the users requesting the imagery, the type of device requesting the imagery, etc. Based on these factors, the entity can determine whether to make a commercial object available to particular or multiple users requesting the geographic imagery. The entity can then request that a commercial object be displayed in conjunction with the geographic imagery. In this manner, the subject matter of the present disclosure can provide a mechanism for entities, such as businesses, to make instant commercial objects available to users navigating the geographic imagery to attract users to engage in commerce with the entity.

Referring now to the FIGS., exemplary embodiments of the present disclosure will now be discussed in detail. The present disclosure is discussed with reference to geographic imagery that includes interactive immersive panoramic imagery, such as street level imagery. Those of ordinary skill in the art, using the disclosures provided herein, should understand that the present subject matter is equally applicable for use with any type of geographic imagery, such as the imagery provided in a virtual globe application (e.g. the Google Earth™ virtual globe application), street map imagery, satellite imagery, aerial imagery, oblique view imagery, or other suitable imagery.

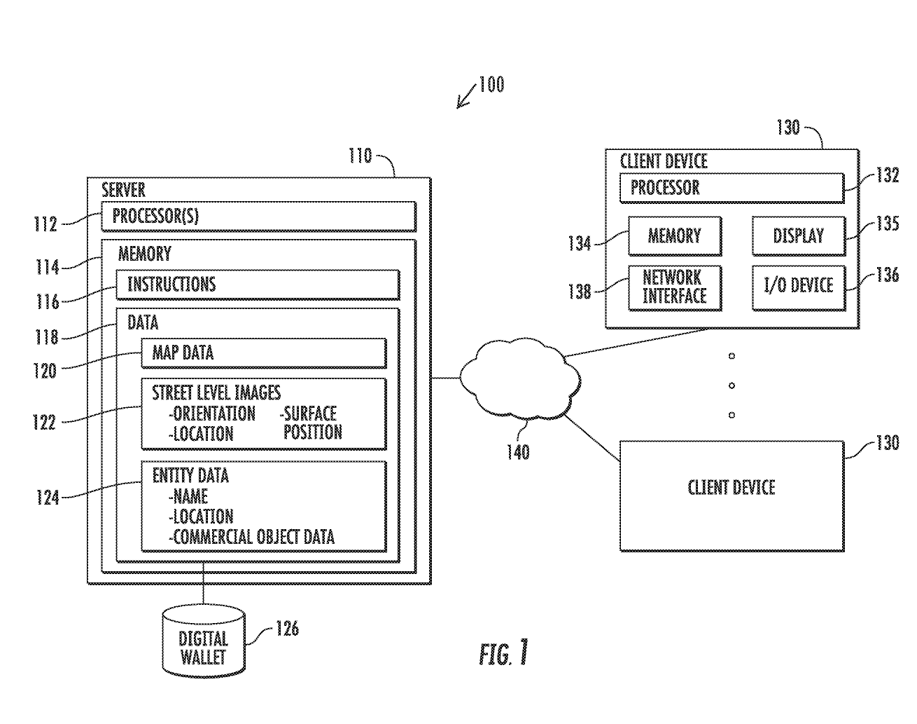

FIG. 1 depicts an exemplary system 100 for displaying panoramic imagery according to an exemplary embodiment of the present disclosure. The system 100 provides for the display of interactive panoramic imagery, such as street level imagery, of a geographic area to users. The system 100 can include a client-server architecture where a server 110 communicates with one or more clients 130 over a network 140. Although two clients are illustrated in FIG. 1, any number of clients 130 can be connected to the server 110 over the network 140. The server 110 can host a geographic information system, such as a mapping application (e.g. the Google Maps™ mapping services provided by Google Inc.), a virtual globe application (e.g. the Google Earth™ virtual globe application provided by Google Inc.), or other suitable geographic information system. On the client-side, each client 130 can present a user interface, such as a browser, that allows a user to interact with the geographic information system. The server 110 transmits data, such as panoramic images and other data, over the network 140 to the client 130. Upon receipt of this data, the client 130 can present panoramic imagery, via the user interface, in a display device associated with the client 130. A user can then interact with the panoramic imagery presented in the user interface to navigate the panoramic imagery as will be discussed in more detail below.

The server 110 can be any computing device, such as a web server, and can include a processor 112 and a memory 114. The memory 114 can store instructions 116 which cause the processor to perform operations. For instance, the memory 114 can store instructions 116 to implement one or more modules for providing panoramic imagery and commercial objects to client devices 130 over the network 140.

It will be appreciated that the term “module” refers to computer logic utilized to provide desired functionality. Thus, a module can be implemented in hardware, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM hard disk or optical or magnetic media.

Memory 114 can also include data 118 used to implement a geographic information system. For instance, memory 114 can include or be coupled to a map database 120, a street level image database 122, and an entity database 124. The server 110 can communicate with other databases as needed. For instance, the server 110 can be coupled to and/or can be in communication with a digital wallet database 126. The databases can be connected to the server 110 by a high bandwidth LAN or WAN, or could also be connected to server 110 through network 120. The databases, including map database 120, the street level image database 122, the entity database 124, and the digital wallet database 126 can be split up so that they are located in multiple locales.

Map database 120 of server 110 stores map-related information, at least a portion of which can be transmitted to a client device 130 over network 140. For example, map database 120 can store map tiles, where each tile is a map image of a particular geographic area. Depending on the resolution (e.g., whether the map is zoomed in or out), one tile can cover a large region (e.g. a State) in relatively little detail. Another tile can cover a much smaller region (e.g. a neighborhood) in relatively high detail. The map information is not limited to any particular format. For example, the images can include street maps, satellite images, aerial images, other suitable images, or a combination of these. The images can be stored as vectors (e.g. in the case of street maps) or bitmaps (e.g. in the case of satellite images and/or aerial images). The various map tiles can be associated with geographic locations such that the server 110 is capable of selecting, retrieving and transmitting one or more tiles in response to a request specifying a particular geographic location.

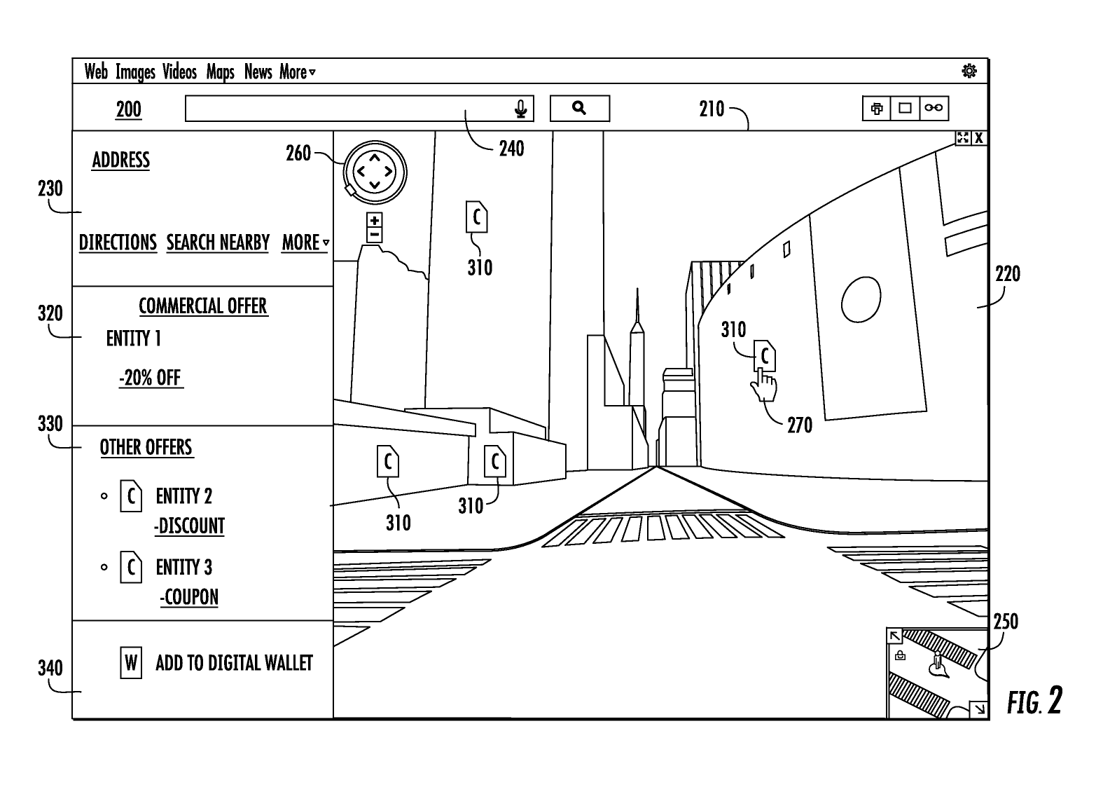

The street level image database 122 stores street level images associated with the geographic locations. Street level images comprise images of objects at geographic locations captured by cameras positioned at the geographic location from a perspective at or near the ground level or street level. Although the term “street level” images is used, the images can depict non-street areas such as trails and building interiors. An exemplary street level image 220 is depicted in FIG. 2. A street level image can depict objects such as buildings, trees, monuments, etc. from a perspective of a few feet above the ground. The street level images can be used to provide an immersive 360° panoramic viewing experience to a user centered around a geographic area of interest.

The images can be captured using any suitable technique using any suitable image capture device. For instance, the street level images can be captured by a camera mounted on top of a vehicle, from a camera angle pointing roughly parallel to the ground and from a camera position at or below the legal limit for vehicle heights (e.g. 7-14 feet). Street level images are not limited to any particular height above the ground. For example, a street level image can be taken from the top of a building. Panoramic street level images can be created by stitching together the plurality of photographs taken from the different angles. The panoramic image can be presented as a flat surface or as a texture-mapped three dimensional surface such as, for instance, a cylinder or a sphere.

Each street level image can be stored as a set of pixels associated with color and brightness values. For example, if the images are stored in JPEG format, the image can be displayed as a set of pixels in rows and columns, with each pixel being associated with a value that defines the color and brightness of the image at the pixel's location. Street level images can also be stored in the form of videos, such as be displaying MPEG videos captured by analog video camera or displaying, in succession, time-sequenced photographs that were captured by a digital still camera.

Similar to map images, street level images stored in the street level image database 122 can be indexed and stored based on geographic location. Locations can be expressed and requested in various ways including, latitude/longitude/altitude positions, street addresses, points on a map (such as when a user clicks or taps on a map), building names, or other data capable of identifying one or more geographic locations.

In addition to being associated with geographic locations, street level images can be associated with orientation data indicating the orientation of the image. For instance, the view angle of a particular street level image can be the angle associated with a particular view of a virtual camera, and can be defined by both a tilt angle and an azimuthal angle. The tilt angle of a view depicted in a street level image can be the angle of the view relative to a horizontal axis. The azimuthal angle can be a specific angle about the 360° panoramic image relative to a reference angle, such as a view angle associated with true north. For instance, the azimuthal angle of a particular view can be 30° east of true north.

The street level image database 122 can also store surface position data concerning the location or position of various surfaces of objects depicted in the street level images. The surface position data can be stored in any number of formats. The position data can include information concerning the location of objects in the three-dimensional space defined by the street level imagery. The position data can be defined in terms of reference to a virtual camera (e.g. the distance to a virtual camera associated with a view presented in a viewport displaying the street level image) and/or in terms of geographic position. As will be discussed in detail below, such information is used to locate the positions of surfaces, in the three dimensional space, of objects depicted in the street level imagery.

In one aspect, the surface position data can include values representing the geographic positions of the surfaces facing the camera in the street level imagery. In that regard, a separate value can be stored for each pixel of the street level image where the value represents the geographic position of the surface of the object illustrated in that particular pixel. For instance, a value representing latitude, longitude, and altitude information associated with the particular surface illustrated in the pixel can be associated with the pixel. In yet another aspect, position data can include distance data that represents the distances of the surfaces of the object depicted in the street level imagery to the virtual camera at each pixel of the street level image. For instance, a value representing the distance to the camera of the surface of the object depicted in the street level image can be associated with each pixel. Pixels that are not associated with a particular surface of an object depicted in the street level images can be associated with a null or default surface value.

In another aspect, the surface position data can include information associated with the locations of the surfaces depicted in street level images as polygons. In particular, a surface of an object depicted in the street level image can be defined as a polygon with four vertices. Each vertex can be associated with a different geographic location. A surface can be referenced in the surface information database as a set of vertices at the various geographic position associated with the object.

Other formats for storing surface position data can also be used. For instance, rather than being associated with absolute position values, such as latitude, longitude, and altitude, the values can be relative and in any scale. Moreover, even if a first type of information is used (such as storing latitude, longitude, and altitude information for the surface) information of another type can be generated from the first type of information (such as differences between positions to calculate distances).

Certain formats permit the surface position data to be stored independently of the street level images. For instance, position data stored as polygons can be stored without reference to the street level image or camera position and can be retrieved by searching for surfaces having geographic locations near the location of the street level image.

A variety of systems and methods can be used to collect the surface position data. For instance, a laser range finder can be used. Alternatively, a three-dimensional model can be generated from a plurality of street level images using a variety of known techniques. For instance, stereoscopic techniques can be used to analyze a plurality of street level images associated with the same scene to determine distances at each point in the images. Once the relative locations of the points in the images are known, a three-dimensional model associated with the geographic area can be generated. The three-dimensional model can include information such as the location of surfaces of objects depicted in the street level imagery.

In yet another aspect, the surface position data can be compiled by using a single video camera, travelling at a particular velocity, to capture the street level imagery. Subsequent frames in the video can be compared to extract the different distances between objects and the camera (e.g. mountains in the distance will stay in the frame much longer than a fire hydrant passing by along the street).

The server 110 can also include an entity database 124. The entity database 124 stores information associated with entities depicted in street level images and in map imagery. As used herein, an “entity” refers to any feature, landmark, point of interest, or other object associated with a geographic location. For instance, an entity can include a business, restaurant, retail outlet, coffee shop, bar, music venue, attraction, museum, theme park, arena, ballpark, stadium, etc. Data associated with the entities can include the name of the entity and the location of the entity, such as longitude, latitude, and altitude coordinates associated with the entity.

The entity database 124 can include information associated with redeemable commercial objects associated with entities. A redeemable commercial object refers to any object of commercial value that can be redeemed at an entity. Exemplary commercial objects can include coupons, promotional offers, discounts, vouchers, gift certificates, etc. Data associated with the commercial objects can include data associated with the type of the commercial object (e.g. Coupon), the specifics of the commercial object (e.g. 20% of purchase of $20 or more), and data used to render a digital representation of the commercial object.

According to aspects of the present disclosure, entities such as businesses can request that certain commercial objects be presented to users in conjunction with street level imagery or other geographic imagery. Entity database 124 can store these commercial objects as well as criteria provided by entities for displaying commercial objects. For instance, an entity can request that a commercial object be displayed only when a threshold number of users are accessing the panoramic imagery depicting the entity. The entity can also specify criteria based on other factors, such as proximity of users accessing the geographic imagery and/or the device type associated with the users accessing the geographic imagery. Data associated with these criteria can be stored in the entity database 124.

As illustrated, the server 110 can also be coupled to or in communication with a digital wallet database 126 associated with digital wallet services, such as the Google Wallet services provided by Google Inc. A digital wallet service can store information optionally provided by a user that is useful for commercial transactions, such as information associated with debit cards, credit cards, commercial objects such as coupons, discounts, promotions, gift cards, etc. The digital wallet service can allow a user to use this information in commercial transactions with the user's mobile device, such as a smartphone. For instance, a user can simply tap the mobile device on a suitable terminal at a checkout to pay for goods or services. The digital wallet database 126 can store information associated with a user's digital wallet account. The information is stored in a secure manner to protect information associated with a user's digital wallet account and is used only for purposes expressly approved by the user.

The server 110 can be configured to receive requests for data, such as data stored in any of the map database 120, the street level image database 122, and/or the entity database 124, and respond to those requests via the network 140. For instance, the server 110 can encode data in one or more data files and provide the data files to a client 130 over the network 140.

A client 130 can be any computing device that can be used by a user to interact with the system 100. For instance, a client can be a personal computer, smartphone, mobile device, desktop, laptop, PDA, tablet, or other computing device. In short, a client 130 can be any computer device or system that can execute instructions to allow a user to interact with the system 100.

The client 130 can include a processor 132 and a memory 134. The processor 132 can be any suitable processing device. The memory 134 can store computer-readable instructions that when executed by the processor 132 cause the processor 132 to perform operations. The client 130 can include various input/output devices 136 for providing and receiving information from a player, such as a touch screen, touch pad, data entry keys, speakers, and/or a microphone suitable for voice recognition. The client 130 can include a display 135 for presenting information, such as street level images, to the user. The client 130 can further include a network interface 138 for providing communications over the network 140. The network interface 138 can be any device/medium that allows the client to interface with the network 140. The client 130 can send a request for panoramic imagery, such as street level imagery, to the server 110 over the network 140 via the network interface 138. The client 130 can then receive panoramic imagery and data associated with the panoramic imagery and present at least a portion of the panoramic imagery through a viewport on any suitable output device set forth in a browser presented on a display 135.

The network 140 can be any type of communications network, such as a local area network (e.g. intranet), wide area network (e.g. Internet), or some combination thereof. The network can also include a direct connection between a client 130 and the server 110. In general, communication between the server 110 and a client 130 can be carried via a network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

FIG. 2 depicts an exemplary user interface 200, such as a browser, that can be presented on a display of a client 130. User interface 200 includes a viewport 210 that displays a portion of immersive panoramic imagery, such as street level image 220. Street level image 220 depicts images of objects captured by one or more cameras from a perspective at or near the ground level or street level. As shown, street level image 220 can provide an immersive viewing experience of a geographic area to a user. Map information 230 can be provided to the user in association with the panoramic imagery. The map information 230 can include an address or other indication of the geographic location associated with the street level image 220. The map information 230 can also include other information, such as thumbnail images associated with objects and/or entities depicted in the image 220. Various options can also be presented to the user, such as the ability to request travel directions, search nearby, and other options.

The user interface 200 can provide flexibility to the user in requesting panoramic imagery associated with a geographic area to be displayed through viewport 210. For instance, the user can enter text in a search field 240, such as an address, the name of a building, or a particular latitude and longitude. The user can also use an input device such as a mouse or touchscreen to select a particular geographic location shown on a map. Yet further, the user interface 200 can provide an icon or other feature that allows a user to request a street level view at the specified geographic location. When providing a street level image through viewport 210, the user interface 200 can indicate the location and orientation of the view with a street level viewpoint signifier 250.

The user interface 200 can include user-selectable controls 260 for navigating the viewpoint associated with the image 220. The controls can include controls for zooming the image in and out, as well as controls to change the orientation of the view depicted in the image 220. The user can also adjust the viewpoint of the street level image 220 using a user manipulable selecting object 270, such as a cursor. For instance, a user can adjust the viewpoint by selecting and dragging the imagery to different views, for instance, with the selecting object 270 or through interaction with a touch screen. If the street level image 220 was downloaded as an entire 360° panorama, changing the direction of the view may necessitate only displaying a different portion of the panorama without retrieving more information from a server.

Other navigation controls can be included as well, such as controls in the form of arrows disposed along a street that can be selected to move the vantage point up and down the street. A user can use the selecting object 270 to transition to various viewpoints within the immersive panoramic imagery. For instance, the user can position the selecting object 270 proximate a geographic object or other feature of interest. The selecting object 270 can appear to contour against the surface of the geographic objects depicted in the street level imagery 220 as the user moves the selecting object within the viewport 210. The position of the selecting object 270 can be based on the surface position information associated with objects depicted in the street level image 220. Upon receiving a user interaction indicative of a request to view a geographic object, the view of the street level image 220 can transition to a closer view of the geographic object of interest. In this manner, a user can use the selecting object 270 to click or tap to go to various geographic locations within the street level imagery 220.

According to aspects of the present disclosure, commercial objects redeemable at entities depicted in the street level image 220 can be displayed to the user in conjunction with the street level image 220. For instance, as shown in FIG. 2, digital representations of commercial objects 310 are depicted overlaying the entities where the commercial objects 310 can be redeemed. In the example shown in FIG. 2, the digital representations of the commercial objects 310 include a rectangular icon with the letter “C.” The digital representation of a commercial object can include an icon, indicia, or other suitable representation of the commercial object. Those of ordinary skill in the art, using the disclosures provided herein, should understand that any suitable digital representation can be used without deviating from the scope of the present disclosure.

As illustrated in FIG. 2, the digital representations of the commercial objects 310 can be rendered with effects such that the commercial objects 310 appear to be located on the surface of the entities where the commercial objects 310 can be redeemed. The effects can be determined based on surface position data associated with the entities depicted in the image 220 as well as the orientation of the image 220 in the viewport. Rendering the commercial objects 310 in this manner can provide a lasting visual impression concerning the location of where the commercial objects 310 are redeemable in the geographic area depicted in the street level image 220.

A user can browse and collect the commercial objects 310 as the user navigates the panoramic imagery. For example, to obtain more information about a specific commercial object 310, a user can position a selecting object 270 proximate the commercial object 310. Information associated with the commercial object can be displayed in a portion of the user interface adjacent to the street level image 220. For example, as shown in FIG. 2, information associated with the commercial object 310 can be displayed in section 320 of the user interface 200. The information can include the type of commercial object 310 (e.g. coupon, discount, gift certificate, etc.) as well as details of the commercial object 310 (e.g. 20% off purchase of $20 or more). Additional information can also be displayed, such as the number of commercial objects 310 that remain in a limited offering of commercial objects 310.

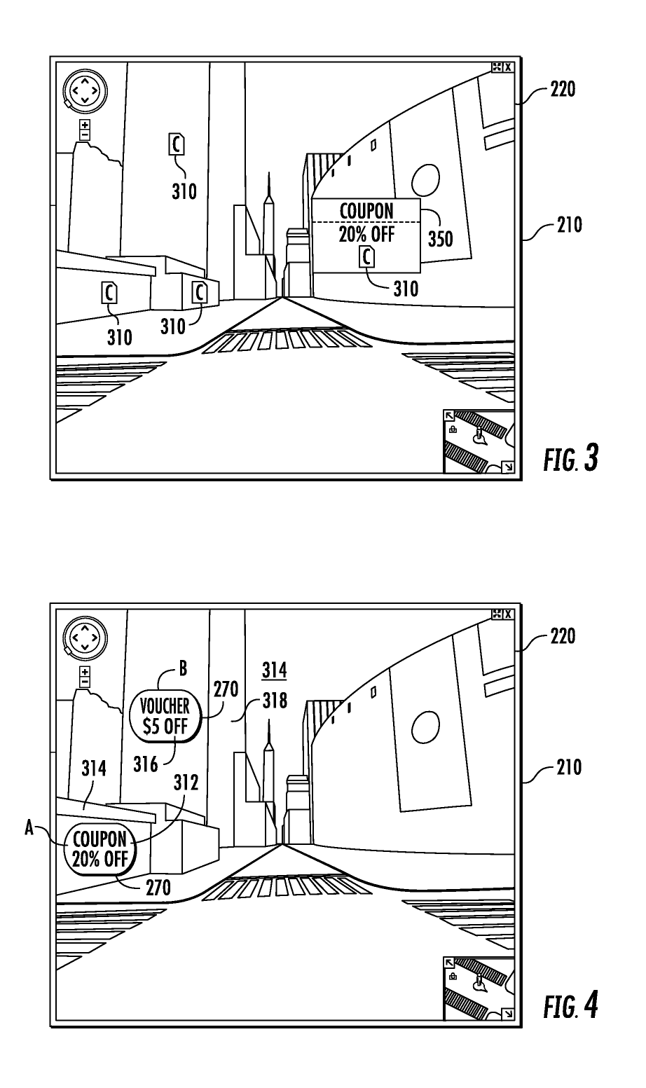

Alternatively, as shown in FIG. 3, the information associated with a commercial object 310 can be displayed overlaying the commercial object 310 or the entity depicted in the panoramic image. For instance, when a user positions a selecting object 270 proximate a commercial object 310, information associated with the commercial object 310 can be presented in a window 350 overlaying the commercial object 310 in the panoramic image. In this aspect, information associated with the commercial object 310 can be presented at a location in the user interface 200 that already at least partially has the user's attention, which may lead to increased user interaction with the commercial object 310.

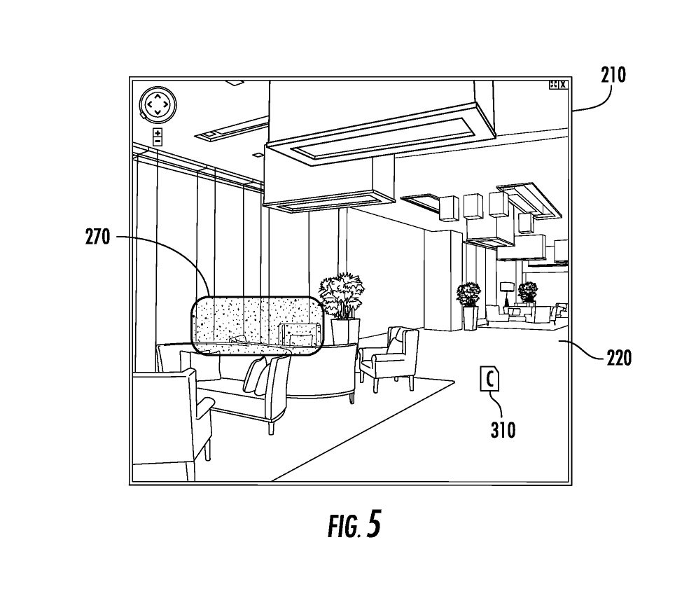

In another embodiment, a commercial object can be displayed within or overlaying the selecting object when the selecting object is positioned proximate an entity where the commercial object can be redeemed. For instance, as shown in FIG. 4, a first commercial object 312 can be presented to the user within the selecting object 270 when the selecting object 270 is located at position A proximate entity 314. A second commercial object 316 can be presented to the user within the selecting object 270 when the selecting object 270 is located at position B proximate entity 318. The first commercial object 312 can be a coupon redeemable at entity 314. The second commercial object 316 can be a discount redeemable at entity 318.

Various techniques can be used for presenting commercial objects to a user based on the position of the selecting object 270 relative to entities depicted in the street level image 220. In one particular implementation, the street level image 220 can include metadata associated with the street level image 220 that is indicative of commercial objects associated with entities depicted in the street level image 220. As the selecting object 270 hovers over a pixel or group of pixels, the commercial object data associated with the pixels can be used to select a commercial object for display within or overlaying the selecting object 270.

In yet another embodiment, a commercial object associated with an entity can be displayed when a user navigates to an interior panoramic image associated with the entity. For example, as shown in FIG. 5, a commercial object 310 can be displayed to the user when the user navigates to the panoramic image 220 associated with the interior view of the entity. The commercial object 310 can be displayed at any convenient location depicted in the panoramic imagery. In one example, the commercial object 310 can be displayed adjacent to check out desk or other point of sale location associated with the entity.

Referring back to FIG. 2, the user interface 200 can also present commercial objects associated with secondary entities that are not depicted in the street level image 220. For instance, a section 330 of the user interface 200 can be used to present information associated with commercial objects redeemable at secondary entities. The commercial objects associated with the secondary entities can be presented in any suitable manner, such as a thumbnail strip located in the user interface 200.

A secondary entity is an entity that is not depicted in the street level image 220 presented in the viewport 210. As one example, secondary entities can include entities that are located proximate the geographic area depicted in the street level image 220, such as within a few blocks of the geographic area depicted in the street level image 220. In this manner, the commercial objects associated with entities depicted in neighboring panoramic images can be provided to the user. The secondary entities can also include competitor entities relative to the entities depicted in the street level image 220. For example, the user interface 200 that presents a commercial object redeemable at a coffee shop depicted in the street level image 220 can also present a commercial object associated with a competing coffee shop (not depicted in the street level image 220) to the user.

A user can interact with the commercial objects 310 to collect the commercial objects 310 for later use. For instance, a user can select (e.g. by clicking or tapping) the commercial objects 310 to find out more information about the commercial objects 310 and to collect the commercial objects 310 so that the user can later redeem the commercial objects 310. In one particular implementation, a user can collect the commercial objects 310 in a digital wallet account. For instance, the user can select (e.g. by clicking or tapping) the digital representation of the commercial objects 330 and drag the commercial objects 330 to a suitable digital wallet icon 340 associated with a digital wallet account. In this manner, a user can collect commercial objects redeemable at entities depicted in the panoramic imagery as the user navigates the panoramic imagery. The user can then redeem one or more of the commercial objects at the physical location of the commercial object depicted in the street level image or at an online website associated with the entity.

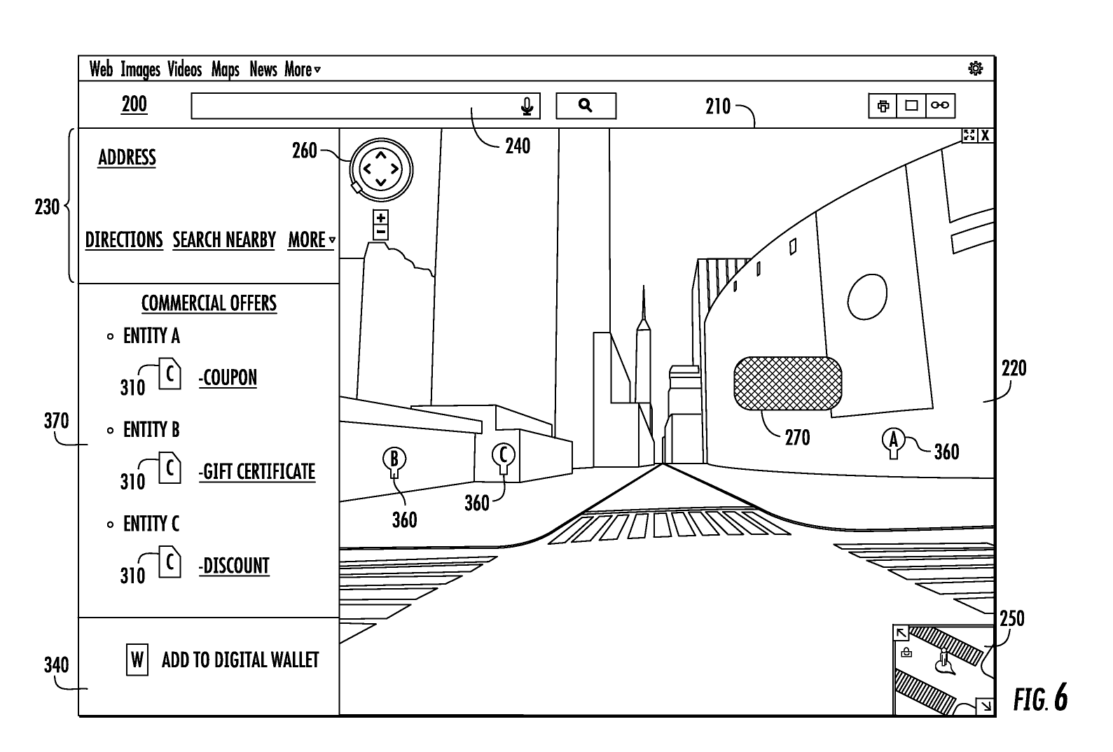

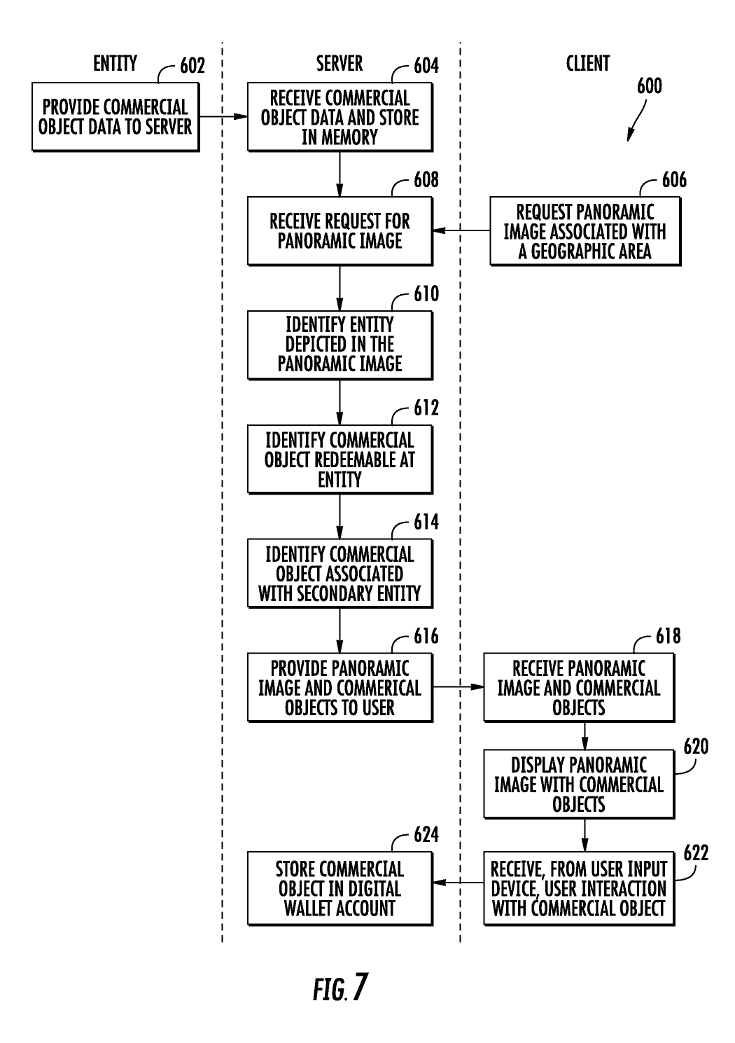

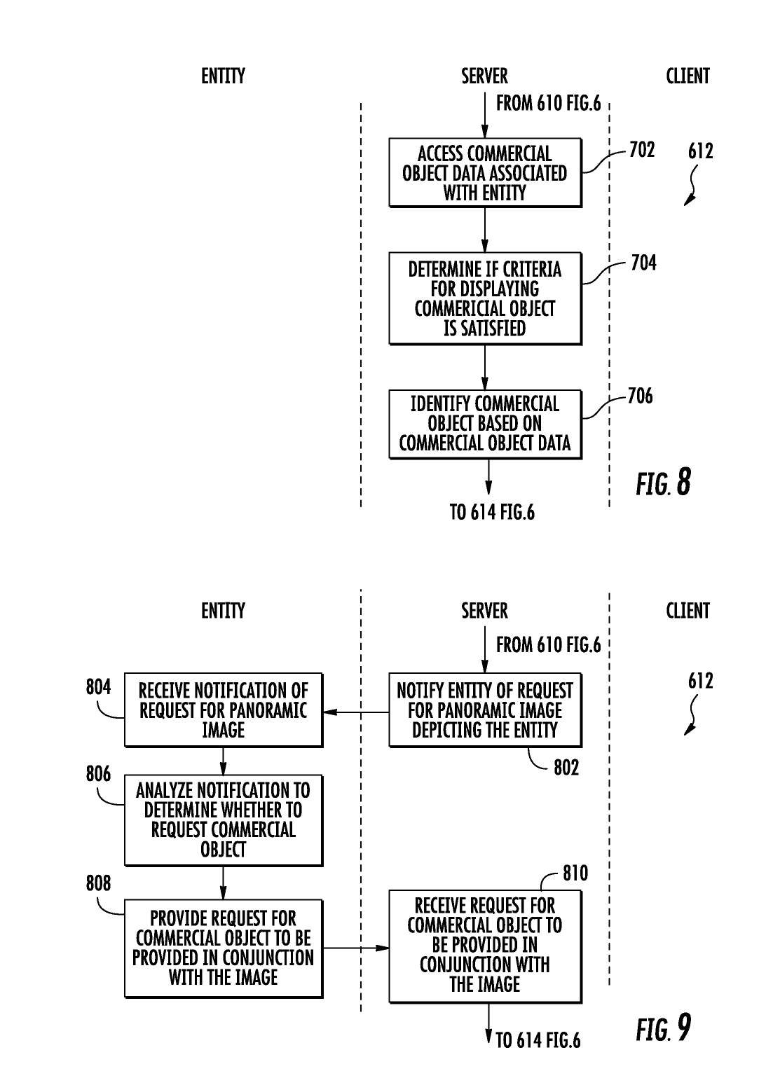

While the above examples discuss rendering commercial objects overlaying entities depicted in the panoramic imagery for purposes of illustration and discussion, the commercial object can be rendered in any manner in conjunction with the panoramic imagery without deviating from the scope of the present disclosure. For example, as shown in FIG. 6, the commercial objects 310 can be rendered in a section 370 of the user interface 200 located proximate to the viewport 210 presenting the street level image 220.

In the example shown in FIG. 6, the section 370 illustrates a coupon commercial object 310 redeemable at entity A, a gift certificate commercial object 310 redeemable at entity B, and a discount commercial object 310 redeemable at entity C. Entities A, B, and C are each depicted in the street level image 220. Suitable indicators 360 can be rendered with the street level image 220 to identify the location of entities A, B, and C in the street level image 220. The indicators 360 can be any suitable indicia or icon that can signify the location of entities in the panoramic image, such as a pin, balloon, or other suitable indicia.

A user can collect and/or find more information about the commercial objects 310 by interacting with the commercial objects. For instance, the user can select (e.g. by clicking or tapping) a link associated with the commercial objects 310. Alternatively, the user can select (e.g. by clicking or tapping) the digital representation of the commercial objects 310. As discussed above, the user can collect the commercial objects 310 and store the commercial objects 310 in a digital wallet account for later user. For instance, the user can select (e.g. by clicking or tapping) a digital representation of the commercial objects 310 and drag the commercial objects 310 to a suitable digital wallet icon 340 associated with a digital wallet account.

Referring now to FIG. 7, an exemplary computer-implemented method 600 for presenting panoramic imagery according to an exemplary embodiment of the present disclosure will now be discussed in detail. The computer-implemented method 600 will be discussed with reference to the client-server architecture of the system 100 depicted in FIG. 1. However, the method 600 can be implemented using any suitable computing environment. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined and/or adapted in various ways.

At (602), an entity provides commercial object data to a server. For example, an entity can send a request over network 140 to server 110 to provide a commercial object in conjunction with a panoramic imagery depicting the entity. The request can be provided by the entity through a suitable user interface presented on a client device 130 accessible by the entity. The user interface can allow the entity to specify the type of commercial object (e.g. coupon, voucher, discount, gift certificate) and details concerning the commercial object, such as specifics of the commercial benefit (e.g. 20% off purchase of $20 or more), validity periods (e.g. valid through end of next month), locations where the commercial object can be redeemed (e.g. all retail locations, including the location depicted in the panoramic imagery), purchase price associated with the commercial object (e.g. $50 gift certificate for purchase price of $25), and other information. In one aspect, an entity can provide the request in conjunction with a promotional offers service, such as the Google Offers promotional offers service provided by Google Inc.

The commercial object data can also include criteria specified by the entity for displaying the commercial object in conjunction with panoramic imagery. The criteria can be based on number of users requesting/accessing panoramic imagery depicting the entity, the proximity of users to the entity requesting/accessing the panoramic imagery, the device type of the user requesting/accessing the imagery and other suitable factors. Any location data, proximity data, device type data or other user data would only be used after the user has provided consent after being informed of what data is used and how the data is used. The user can determine how the data is used and can opt-out of such services at any time.

For example, an entity can specify that the commercial object is to be provided in conjunction with a panoramic image depicting the entity only if a threshold number of users have accessed/requested the panoramic image. As another example, the entity can specify that the commercial object is to be provided in conjunction with a panoramic image depicting the entity only to those users within a predefined radius of the location. As yet another example, the entity can specify that the commercial object can only be provided to users having a particular device type, such as a mobile device. This can allow entities to provide commercial objects to relatively mobile users in areas proximate to the geographic location of the entity to encourage spontaneous commercial activity at the entity. In one particular implementation, an entity can specify different types of commercial objects depending on the device type and proximity of the user. This can provide the entity flexibility in specifying criteria for commercial objects tailored to specific types of users requesting panoramic imagery.

Referring to FIG. 7, the commercial object data is received at the server at (604) and stored in a memory. For instance, the commercial object data is received over the network 140 stored in the entity database 124. The commercial object data can be stored and/or indexed in any suitable manner to facilitate access of the commercial object data by the server. In one aspect, the commercial object data is indexed by entity so that when an entity depicted in a panoramic image is identified, the commercial object data associated with the entity can be easily retrieved.

At (606) a user can send a request from a client device to view panoramic imagery. For instance, a user interacting with the geographic system 100 through a user interface (e.g. browser) executed on a client device 130 can request to view panoramic imagery, such as street level imagery, associated with a particular geographic area. The user can request the panoramic imagery in a variety of different manners. For example, the user can enter a geographic location in a search field provided through the user interface and/or the user can navigate to a new geographic area while navigating the panoramic imagery through one of a variety of navigation tools.

At (608), the server receives the request for the panoramic imagery from the user. For instance, the server 110 receives a request to view geographic imagery from a client device 130 over network 140. Once the request has been received and the server has identified panoramic imagery responsive to the request, the server can analyze the panoramic imagery and/or data associated with the panoramic imagery to identify an entity depicted in the panoramic image as illustrated at (610).

The server can identify an entity depicted in the panoramic image using any suitable analysis techniques. In one example, the server can analyze orientation data and/or geographic location data associated with panoramic image to identify an entity depicted in the image. For instance, the server 110 can access orientation data and/or location data stored in the street level image database 122. Each particular orientation and/or location can be mapped to one or more entities. For example, a panoramic image having a particular orientation and location can be mapped to one or more entities associated with that orientation and location. The server can identify the one or more entities mapped to the particular orientation and/or geographic location associated with the panoramic image.

Once the entity or entities have been identified, the server can identify a commercial object redeemable at the entity or entities (612). FIG. 8 depicts one exemplary method that can be implemented to identify a commercial object redeemable at an entity depicted in the panoramic image. As shown, the server can access commercial object data associated with the identified entity (702). In particular, the server can access commercial object data previously provided by the entity prior to receiving the request for the panoramic image by the user, such as the commercial object data provided to the server by the entity at (602) of FIG. 7. In a particular implementation, the server 110 can access commercial object data stored in the entity database 124 associated with the identified entity.

Referring to FIG. 8 at (704), the server can analyze the commercial object data to determine if any criteria specified by the entity for providing the commercial object in conjunction with the panoramic image are satisfied. For example, the server can determine whether a threshold number of viewers has requested/accessed the panoramic imagery. As another example, the server can determine whether proximity and/or device type requirements are satisfied. If the server determines that any criteria are satisfied, the server can then identify the commercial object to be displayed in conjunction with the panoramic imagery based on the commercial object data provided by the entity (706).

FIG. 9 depicts another exemplary method that can be implemented to identify a commercial object according to an exemplary embodiment of the present disclosure. Instead of accessing commercial object data previously provided by an entity and stored in a memory, the server can notify the entity of a request to view panoramic imagery depicting the entity and receive a request from the entity in response to the notification to include a commercial object with the panoramic image depicting the entity. This allows for instant commercial objects to be displayed in conjunction with panoramic imagery based at least in part on close to real time input from the entities depicted in the panoramic imagery.

More particularly at (802), the server can notify the entity that a request for panoramic imagery depicting the entity has been received. For instance, the server 110 can send a notification over the network 140 to a client device 130 accessible by the entity. The notification can include data providing various details associated with the request for the panoramic image. For instance, the notification can include data providing the number of users requesting/accessing the panoramic image, the proximity and/or location of users accessing the image, and the device type of the user's making the request (if such users have provided express permission to use such information after notifying the users of how the information will be used).

At (804), the entity receives the notification. For instance, a client device 130 accessible by the entity can receive the notification from the server 110 over the network 140. The notification and associated information can be presented to the entity in a suitable user interface and stored in a memory at the client device 130 accessible by the entity. At (806), the entity can analyze the notification and associated information to determine whether to request a commercial object to be provided in conjunction with the panoramic image depicting the image. For instance, the notification and associated data can be analyzed to determine whether certain criteria, such as number of users accessing the panoramic image, the proximity of the users, the device type of the users, etc., are satisfied. The notification can be analyzed by a module executed on the client device accessible by the entity or by a user associated with the entity.

If it is determined, based on the notification, to provide a commercial object, the entity provides a request to include a commercial object in conjunction with the panoramic image to the server (808). As set forth above, the request can include information associated with the commercial object, such as the type of commercial object and details associated with the commercial object. At (810) the server receives the request for the commercial object to be provided in conjunction with the panoramic image.

Referring back to FIG. 7, once the commercial object has been identified, the server can identify any commercial objects associated with secondary entities to be provided in conjunction with the panoramic image (614). As discussed above, a secondary entity is an entity not depicted in the panoramic image. For example, a secondary entity can be a competitor entity of an entity depicted in the panoramic image or an entity located proximate to the geographic area depicted in the panoramic image. Any suitable techniques can be used to identify commercial objects associated with secondary entities, such as the techniques discussed with reference to FIGS. 7 and 8 above.

At (616), the server provides the panoramic image responsive to the request and data associated with the identified commercial objects to the client device associated with the user requesting the panoramic image. For instance, the server 110 can provide the panoramic image and data associated with identified commercial objects to a client device 130 over the network 140. The data associated with the identified commercial objects can include data used to render digital representations of the identified commercial objects in conjunction with the panoramic image, such as data specifying effects to make the commercial objects appear to lie on the surface of the entities depicted in the panoramic image.

At (618), the client device accessible by the user receives the panoramic image and data associated with the identified commercial objects. The client device then displays the commercial objects in conjunction with the panoramic image in a suitable user interface such as a browser (620). Exemplary user interfaces for presenting commercial objects in conjunction with panoramic imagery are depicted in FIGS. 2-5.

Referring to FIG. 7 at (622), the client device accessible by the user can receive a user interaction with a commercial object presented in conjunction with the panoramic image. The user interaction can be indicative of the user's desire to collect the commercial object. For instance, the user can use an appropriate input device to select (e.g. by clicking or tapping) the commercial object and drag the commercial object to a suitable location indicative of the user's desire to collect the commercial object in a digital wallet account. Responsive to the user input, the client device can notify the server of the user interaction indicative of the user's desire to collect the commercial object in a digital wallet account. The server can then update the digital wallet account associated with the user to include the collected commercial object (624).

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method implemented by one or more computing devices for providing geographic imagery, comprising:
receiving, by the one or more computing devices, a request for a geographic image, the geographic image depicting a geographic area associated with a location;
identifying, by the one or more computing devices, at least one entity depicted in the geographic image;
identifying, by the one or more computing devices, a commercial object redeemable at the entity for display in conjunction with the geographic image; and
responsive to the request for the geographic image, providing, by the one or more computing devices, data for displaying a representation of the commercial object redeemable at the entity in conjunction with the geographic image;
wherein identifying, by the one or more computing devices, a commercial object redeemable at the entity for display in conjunction with the geographic image, comprises:
providing, by the one or more computing devices, a notification to the entity, the notification comprising the number of users accessing the geographic image; and
in response to the notification receiving, by the one or more computing devices, a request from the entity to display the representation of the commercial object redeemable at the entity in conjunction with the geographic image based at least in part on the number of users accessing the geographic image.

2. The computer-implemented method of claim 1, wherein the commercial object comprises a coupon, a voucher, a promotional offer, a discount, or a gift certificate.

3. The computer-implemented method of claim 1, wherein the method further comprises:
receiving, by the one or more computing devices, data indicative of a user interaction with the representation of the commercial object; and
storing, by the one or more computing devices, the commercial object in a digital wallet account.

4. The computer-implemented method of claim 1, wherein the at least one entity is identified in the geographic image based at least in part on orientation information associated with the geographic image.

5. The computer-implemented method of claim 1, wherein the at least one entity is identified in the geographic image based at least in part geographic information associated with the geographic image.

6-7. (canceled)

8. The computer-implemented method of claim 1, wherein the notification provided to the entity comprises a device type associated with the request.

9-10. (canceled)

11. The computer-implemented method of claim 1, wherein the method comprises:
identifying, by the one or more computing devices, at least one secondary entity;
identifying, by the one or more computing devices, a commercial object redeemable at the secondary entity; and
responsive to the request for the geographic image, providing, by the one or more computing devices, data for displaying a representation of the commercial object redeemable at the secondary entity in association with the geographic image.

12. The computer-implemented method of claim 11, wherein the secondary entity is located proximate to the geographic area depicted in the geographic image.

13. The computer-implemented method of claim 11, wherein the secondary entity is a competitor with the at least one entity depicted in the geographic image.

14-16. (canceled)

17. A computing system for displaying panoramic images, comprising:
a first computing device comprising a network interface, one or more processors, and at least one memory, the at least one memory storing first computer-readable instructions for execution by the one or more processors to perform a first set of operations, the first set of operations comprising:
receiving, via the network interface, a request for a panoramic image, the panoramic image depicting a geographic area associated with a location captured by a camera;
identifying, with the one or more processors, at least one entity depicted in the panoramic image;
identifying a commercial object redeemable at the entity for display in conjunction with the panoramic image; and
responsive to the request for the panoramic image, providing data for displaying a representation of the commercial object redeemable at the entity in association with the panoramic image;
wherein the operation of identifying a commercial object redeemable at the entity for display in conjunction with the geographic image comprises:
accessing commercial object data provided by the entity prior to receiving the request, the commercial object data specifying criteria for displaying one or more commercial objects, the criteria specifying a threshold of the number of users requesting the geographic image; and
identifying a commercial object based on the threshold number requesting the geographic image.

18. The computing system of claim 17, wherein the first set of operations further comprise:
receiving, via the network interface, data indicative of a user interaction with the representation of the commercial object; and
storing the commercial object in a digital wallet account.

19. The computing system of claim 17, wherein the computing system further comprises a second computing device coupled to the first computing device over a network, the second computing device comprising a user input device, a display device, one or more processors, and at least one memory, the at least one memory storing second computer-readable instructions for execution by the one or more processors to perform a second set of operations, the second set of operations comprising:
transmitting the request to the first computing device over the network;
responsive to the request, receiving the panoramic image and the data for displaying the representation of the commercial object in conjunction with the panoramic image from the first computing device; and
displaying the panoramic image and the representation of the commercial object on the display device.

20. The computing system of claim 19, wherein the representation of the commercial object is displayed overlaying the at least one entity depicted in the panoramic image.

21. The computing system of claim 17, wherein the criteria specify a first type of commercial object to be displayed to users accessing the geographic imagery from a first type of device and a second type of commercial object to be displayed to users accessing the geographic imagery from a second type of device.
